(19) United States
(12) Patent Application Publication
(10) Pub. No.: US 2016/0269494 A1
(43) Pub. Date: Sep. 15, 2016

(54) APPARATUS AND METHOD FOR PROVIDING OBJECT-ORIENTED SERVICES

(71) Applicant: Electronics and Telecommunications Research Institute, Daejeon-si (KR)

(72) Inventor: Nam Kyung LEE, Daejeon-si (KR)

(73) Assignee: Electronics and Telecommunications Research Institute, Daejeon-si (KR)

(21) Appl. No.: 15/042,510

(22) Filed: Feb. 12, 2016

(30) Foreign Application Priority Data
Mar. 10, 2015 (KR) 10-2015-0033299

(51) Int. Cl. H04L 29/08; H04W 4/00

(52) U.S. Cl. CPC H04L 67/16; H04W 4/005

(57) ABSTRACT

Disclosed is an apparatus and method for providing object-oriented services. The apparatus for providing object-oriented services includes: an object pool generator configured to generate a pool of service objects based on at least one service using entity and at least one service providing entity; a service relationship analyzer configured to analyze a service relationship by dividing the service objects into a service requesting object and a service providing object based on information on the service objects, for services capable of being transmitted and received between the service objects; and a service generator configured to generate the services, capable of being transmitted and received between the service objects, by using the analyzed service relationship.

### CROSS-REFERENCE TO RELATED APPLICATION(S)

This application claims priority from Korean Patent Application No. 10-2015-0033299, filed on Mar. 10, 2015, in the Korean Intellectual Property Office, the entire disclosure of which is incorporated herein by reference for all purposes.

### BACKGROUND

1. Field

The following description generally relates to a technology for providing object-oriented services, and more particularly to an apparatus and method for providing object-oriented services in a smart-home environment.

2. Description of the Related Art

With the development of the Internet, home appliances have been rapidly developed into smart electronic devices that may be connected to a network with communication modules mounted therein to provide services. Most home appliances have a MICOM (microcomputer) and programs to perform operations, such that the appliances may be controlled and operated according to the programs, and may perform additional operations or may control external programs. Moreover, an environment of Internet-based home network has been created in which a home gateway may also be connected to the Internet through a network to enable a user to control home electronic devices even when the user is outside the home. The home gateway may be further developed to be connected to a higher-level platform of integrated control services to provide additional services. The platform of integrated control services is not limited to a specific service, but may be established as a common platform where various services may be developed and provided.

In addition, with the development of a local network technology and a mobile communication network as well as the development of sensor devices, a smart home infrastructure has been built, and Machine To Machine (M2M) communications have been realized, such that all the home electronic device (home appliances) may be remotely monitored and controlled. Particularly, smartphones are used not only as a telephone communication device but also as a portable information device that is essential in our daily activities. However, a general smart home service based on the M2M communications has a drawback in that as services are provided to a user by using object information, the user is the only entity that uses the object information and controls services.

### SUMMARY

Provided is an apparatus and method for analyzing a service flow relationship between a user and objects and between objects.

Further, provided is an apparatus and method for providing object-oriented services.

In one general aspect, there is provided an apparatus for providing object-oriented services, the apparatus including: an object pool generator configured to generate a pool of service objects based on at least one service using entity and at least one service providing entity; a service relationship analyzer configured to analyze a service relationship by dividing the service objects into a service requesting object and a service providing object based on information on the service objects, for services capable of being transmitted and received between the service objects; and a service generator configured to generate the services, capable of being transmitted and received between the service objects, by using the analyzed service relationship.

The service objects may be objects which request or provide the services.

The service relationship analyzer may analyze the service relationship by dividing the service objects into the service requesting object and the service providing object, wherein the service relationship includes information on whether the service objects have received the services.

The service generator may generate a mashup service, wherein one or more services capable of being transmitted and received between the service objects have been mashed up, by using the analyzed service relationship.

The apparatus may further include an information acquirer configured to acquire information on the service using entity or the service providing entity that is connected to a service network.

The apparatus may further include a service output component configured to divide a plurality of objects in the services, generated by the service generator, into the service requesting object and the service providing object, and to output the services by the service providing object the service requesting object in response to a request of the service requesting object.

The apparatus may further include a service list output component configured to output a list of the services capable of being provided to the service requesting object.

### BRIEF DESCRIPTION OF THE DRAWINGS

FIG. 1 is a diagram illustrating an apparatus for providing object-oriented services according to an exemplary embodiment.

FIG. 2 is a diagram illustrating an apparatus for providing object-oriented services according to another exemplary embodiment.

FIG. 3 is a flowchart illustrating a method of providing object-oriented services according to an exemplary embodiment.

FIG. 4 is a flowchart illustrating a method of providing object-oriented services according to another exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the present disclosure will be described in detail with reference to the accompanying drawings. The drawings described herein are for illustrative purposes only, and thus are not intended to limit the scope of the present disclosure. In addition, it will be apparent to those skilled in the art that various modifications and changes thereto can be made within the scope of the invention defined by the claims.

Further, terms used throughout this specification are defined in consideration of functions according to exemplary embodiments, and can be varied according to a purpose of a user or manager, or precedent and so on. Thus, the meanings of the terms used in the following embodiments shall follow the definitions if defined herein, otherwise shall have the same meaning as is commonly understood by one of skill in the art to which this invention belongs.

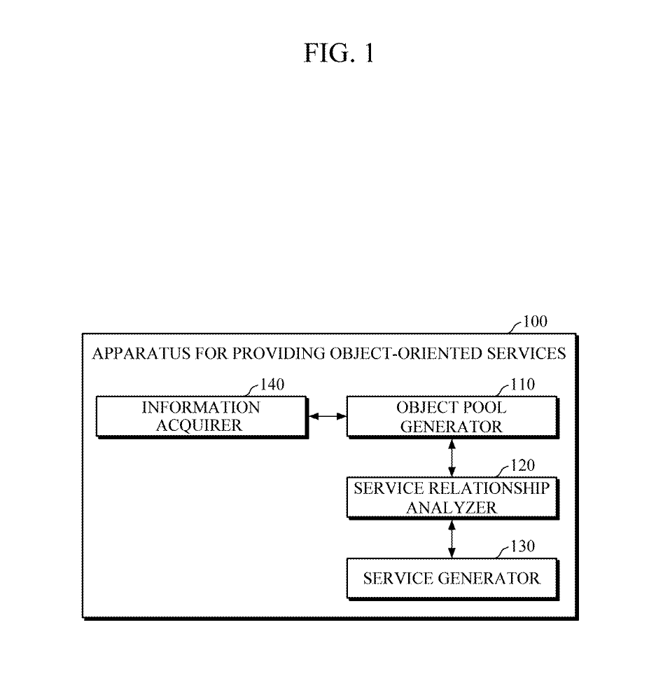

FIG. 1 is a diagram illustrating an apparatus for providing object-oriented services according to an exemplary embodiment.

Referring to FIG. 1, the apparatus 100 for providing object-oriented services includes an object pool generator 110, a service relationship analyzer 120, and a service generator 130.

The apparatus 100 for providing object-oriented services illustrated in FIG. 1 is merely illustrative, and the apparatus 100 for providing object-oriented services may include only some of the modules illustrated in FIG. 1, and/or may further include other modules necessary for its operation. For example, the apparatus 100 for providing object-oriented services may further include an input that may receive information from a user.

Hereinafter, the object pool generator 100, the service relationship analyzer 120, and the service generator 130 are described as individual elements, but may be implemented in a single element, a single physical device, or a single module. For example, the object pool generator 100, the service relationship analyzer 120, and the service generator 130 may be implemented by separate operations or a plurality of operations in a single server or in a plurality of servers, or may be implemented by a single operation. In addition, the object pool generator 100, the service relationship analyzer 120, and the service generator 130 may be implemented as a plurality of physical devices or groups thereof, rather than as an individual physical device or a group of physical devices.

The object pool generator 110 generates a pool of service objects based on at least one service using entity and at least one service providing entity.

Here, the service using entity refers to an object that sends a service request to a service providing entity and receives the requested service from the service providing entity. For example, the service using entity may be a user that uses services in a smart home service environment. In another example, the service using entity may be a service requester that is connected to a service network. The service providing entity may be an object that provides services to the service using entity in response to a service request of the service using entity. For example, the service providing entity may be a thing, a service receiver, or the like which provides services in a smart home service environment. The pool of service objects may refer to a place of resources to objectify both the service using entity and the service providing entity and to manage the entities. By having the service using entity and the service providing entity in a pool of service objects as resources, the entities may be managed in a single concept of service objects.

Information on the service using entity and the service providing entity may be managed as a list or may be stored in a database by the apparatus 100 for providing object-oriented services. In addition, information on the service using entity and information on the service providing entity may be managed separately in an external system, and the apparatus 100 for providing object-oriented services may be connected to the external system through a communication network to receive or acquire the information on the service using entity and the information on the service providing entity. Alternatively, the information on the service using entity and the information on the service providing entity may be acquired from a user through an input.

The service relationship analyzer 120 analyzes a service relationship by using a pool of service objects generated by the object pool generator 110, and by dividing the service objects into a service requesting object and a service providing object with respect to services that may be transmitted and received between the service objects. In one exemplary embodiment, the service relationship analyzer 120 may generate an object knowledge base by using the analyzed service relationship.

Here, the analysis of a service relationship refers to analyzing roles of at least one or more service objects for a specific service. For example, a specific service object may be an object that sends a request for a first service to a first service object. Further, a specific service object may be an object that provides a first service to a first service object. In addition, a specific service object may be not only an object that sends a request of a first service to a first service object, but also an object that provides a second service to a first service object or a second service object. A service relationship between objects may be analyzed to be a network type relationship, since specific service object may send or receive services to and from at least one service object.

In one aspect, a service object may request or provide services. In another aspect, a service object may request and provide services. In one exemplary embodiment, based on the analysis by the service relationship analyzer 120, a specific service object may be an object that sends a request of a first service to a first service object. In another exemplary embodiment, based on the analysis by the service relationship analyzer 120, a specific service object may be an object that provides a first service to a first service object. In yet another exemplary embodiment, based on the analysis by the service relationship analyzer 120, a specific service object may be an object that not only sends a request of a first service to a first service object but also provides a second service to a second service object. In still another exemplary embodiment, based on the analysis by the service relationship analyzer 120, a specific service object may be an object that sends a request of a first service and a second service to a first service object. A relationship among a plurality of service objects may vary depending on the types of services that may be generated among a plurality of service objects.

For example, assuming that the service relationship analyzer 120 analyzes a service relationship between a temperature sensor object and an air conditioner object, the temperature sensor object may be an object that provides information on the sensed temperatures to other objects including the air conditioner object. In another example, the air conditioner object may be an object that sends a request of temperature information to the temperature sensor object and receives a service, i.e., temperature information provided by the temperature sensor, and provides information on the state of the air conditioner object to a user's smart terminal or the like. That is, the air conditioner object, which is a thing, sends a request to the temperature sensor object which is another thing, and may receive a service from the temperature sensor object. In the above example, the air conditioner object may be an object that not only requests a service but also provides a service. In another example, a user may control the air conditioner object to send a service request to the temperature sensor object and to receive the requested service.

In one exemplary embodiment, the service relationship analyzer 120 may analyze a service relationship by dividing service objects into a service requesting object and a service providing object for services that may be transmitted and received between the service objects, in which the services include information on whether service objects have received services. If a specific service object fails to receive a service from other service object, the specific service object may not send a service request to other service object. For example, while the temperature sensor object may be an object that provides temperature information to other service object, the temperature sensor object may not receive a service from other service object. That is, the temperature sensor object may not be an object that sends a service request to other service object.

The service generator 130 generates services that may be transmitted and received between service objects based on a service relationship analyzed by the service relationship analyzer 120. For example, the temperature sensor object may provide information on the sensed temperature to a user object or a smart terminal, and the service generator 130 may generate a service of providing, by the temperature sensor object, information on the sensed temperature to a user object or a smart terminal.

In one exemplary embodiment, the service generator 130 may generate a mash-up service, in which one or more services that may be transmitted and received between objects are mashed up by using the service relationship analyzed by the service relationship analyzer 120.

In general, a mashup refers to a web page or web application that uses content from web service providers or open API providers to create a single new service or combined application. For example, as in the case of combining search-related application interface (API), map-related API, and other various web service information that are made public by Google, and applying the combined information to the sales of real estate (e.g.: HousingMaps.com), a mashup is a web page or web application that combines content from more than one source to create a single new service.

In the present disclosure, the mashup service refers to a single new service provided by combining services that may be transmitted and received between service objects. For example, the service generator 130 may mash-up a service of acquiring temperature information from the temperature sensor object and a service provided by the air conditioner object, so as to generate a service of operating or halting the air conditioner object or controlling the temperature of the air conditioner object according to the temperature information received from the temperature sensor object.

In one exemplary embodiment, the apparatus 100 for providing object-oriented services may further include an information acquirer 140.

The information acquirer 140 may acquire information on a service using entity or a service providing entity which is connected to a service network. In this case, the object pool generator 110 may generate a pool of service objects based on at least one service using entity and at least one service providing entity acquired by the information acquirer 140. In one exemplary embodiment, the service network may be a service network in a smart home environment.

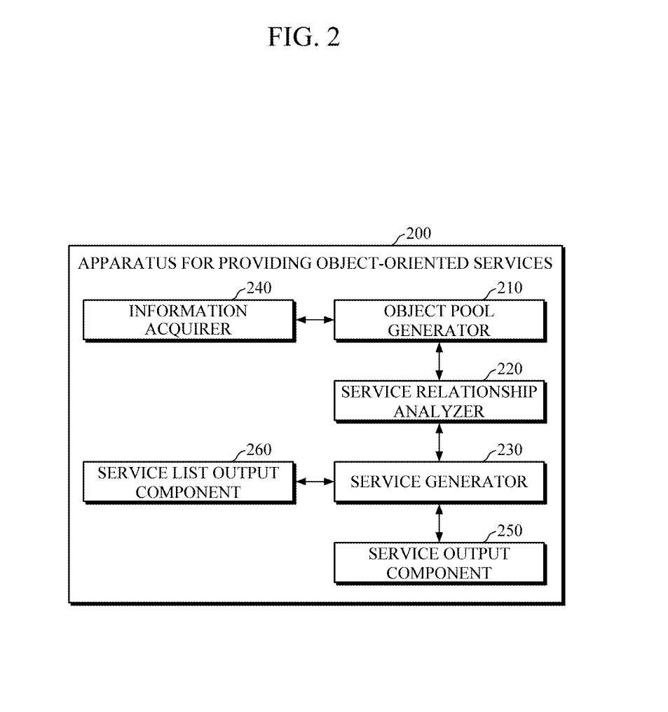

FIG. 2 is a diagram illustrating an apparatus for providing object-oriented services according to another exemplary embodiment.

Referring to FIG. 2, an apparatus 200 for providing object-oriented services includes an object pool generator 210, a service relationship analyzer 220, a service generator 230, an information acquirer 240, and a service output component 250. In one exemplary embodiment, the apparatus 200 for providing object-oriented services may further include a service list output component 260 and a service requester 270.

The apparatus 200 for providing object-oriented services illustrated in FIG. 2 is merely illustrative, and the apparatus 200 for providing object-oriented services may include only some of the modules illustrated in FIG. 2, and/or may further include other modules necessary for its operation. For example, the apparatus 200 for providing object-oriented services may further include an input that may receive information from a user.

The apparatus 200 for providing object-oriented services is different from the apparatus 100 for providing object-oriented services illustrated in FIG. 1 in that the apparatus 200 for providing object-oriented services further includes the service output component 250, the service list output component 260, and/or the service requester 270. Hereinafter, the apparatus 200 for providing object-oriented services will be described with a focus on the difference from the apparatus 100 for providing object-oriented services. Accordingly, matters not specifically described herein with respect to the apparatus 200 for providing object-oriented services illustrated in FIG. 2 are described above with reference to FIG. 1 illustrating the apparatus 100 for providing object-oriented services, except for the matters regarding characteristics of each element.

Hereinafter, the object pool generator 210, the service relationship analyzer 220, the service generator 230, the information acquirer 240, the service output component 250, the service list output component 260, and the service requester 270 are described as individual elements, but may be implemented in a single element, a single physical device, or a single module. For example, the object pool generator 210, the service relationship analyzer 220, the service generator 230, the information acquirer 240, the service output component 250, the service list output component 260, and the service requester 270 may be implemented by separate operations or a plurality of operations in a single server or in a plurality of servers, or may be implemented by a single operation. In addition, the object pool generator 210, the service relationship analyzer 220, the service generator 230, the information acquirer 240, the service output component 250, the service list output component 260, and the service requester 270 may be implemented as a plurality of physical devices or groups thereof, rather than as an individual physical device or a group of physical devices.

The service output component 250 divides a plurality of objects of the service generated by the service generator 230 into a service requesting object and a service providing object, and outputs, by the service providing object, the service in response to a service request of the service requesting object.

For example, a temperature sensor object may provide information on the sensed temperature to a user or a smart terminal, and the service generator 230 may generate a service of providing, by the temperature sensor object, the information on the sensed temperature to a user or a smart terminal. The service output component 250 outputs a service of providing information on the sensed temperature to a user or a smart terminal that requests the service generated by the service generator 230 and provided by the temperature sensor object.

The service list output component 260 outputs a list of services that may be provided to service requesting objects.

In one exemplary embodiment, the service list output component 260 may output a list of services that may be provided to a user or a smart terminal that requests a service. For example, the service list output component 260 may output a list of services, including a service of providing temperature information sensed by a temperature sensor object to a user or a smart terminal or a service of providing state information of an air conditioner object to a user or a smart terminal.

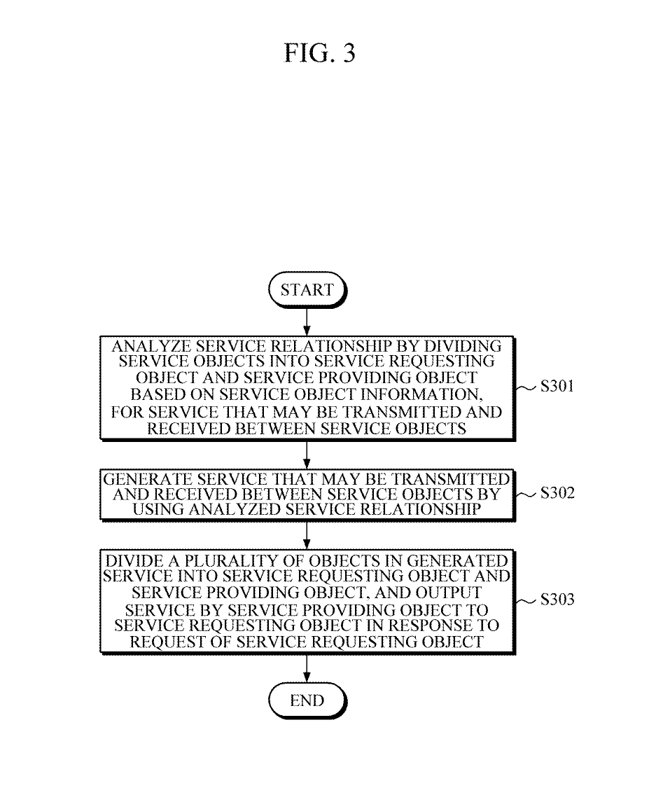

FIG. 3 is a flowchart illustrating a method of providing object-oriented services according to an exemplary embodiment. The processes described hereinafter, along with the exemplary embodiments of the present disclosure, may be implemented in various manners. The method of providing object-oriented services illustrated in FIG. 3 may be a method of providing object-oriented services by using the apparatus 100 or 200 for providing object-oriented services illustrated in FIG. 1 or FIG. 2, or by using an electronic device that includes the apparatus 100 or 200. Accordingly, in order to avoid unnecessary repetition, the method of providing object-oriented services will be briefly described, and matters not described herein are described above with reference to FIGS. 1 and 2.

Referring to FIG. 3, the method of providing object-oriented services includes: analyzing a service relationship by dividing service objects into a service requesting object and a service providing object based on information on the service objects in S310, for services that may be transmitted and received between the service objects; generating services that may be transmitted and received between the service objects by using the analyzed service relationship in S302; and dividing a plurality of objects in the generated services into a service requesting object and a service providing object, and in response to a request of the service requesting object, outputting the services at the service providing object to the service requesting object in S303.

In S301 in the method of providing object-oriented services, a service relationship is analyzed by dividing service objects into a service requesting object and a service providing object by using information on the service objects for services that may be transmitted and received between service objects. Here, the service object may be an object that may request and/or provide services.

The service relationship may be analyzed by dividing service objects into a service requesting object and a service providing object for services that may be transmitted and received between the service objects, in which the analysis may include information on whether service objects have received services.

Then, services that may be transmitted and received between the objects may be generated by using the analyzed service relationship in S302. In this case, a mash-up service may be generated, in which one or more services that may be transmitted and received between the objects have been mashed up, by using the service relationship.

Subsequently, a plurality of objects in the generated services are divided into a service requesting object and a service providing object, and in response to a request of the service requesting object, the service providing object outputs the services to the service requesting object in S303.

In one exemplary embodiment, the method of providing object-oriented services may further include outputting a list of services that may be provided to the service requesting object.

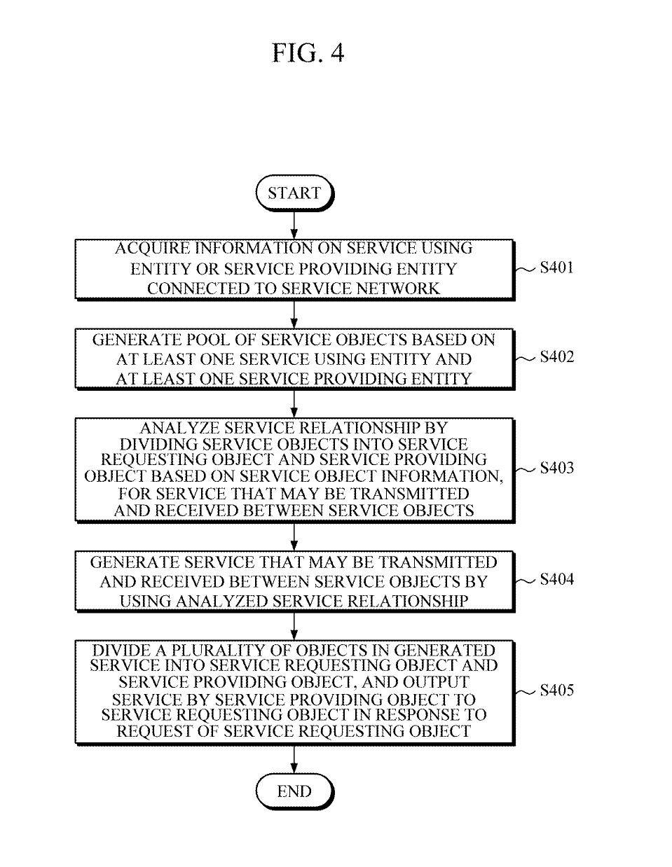

FIG. 4 is a flowchart illustrating a method of providing object-oriented services according to another exemplary embodiment. The processes described hereinafter, along with the exemplary embodiments of the present disclosure, may be implemented in various manners. The method of providing object-oriented services illustrated in FIG. 4 may be a method of providing object-oriented services by using the apparatus 100 or 200 for providing object-oriented services illustrated in FIG. 1 or FIG. 2, or by using an electronic device that includes the apparatus 100 or 200. Accordingly, in order to avoid unnecessary repetition, the method of providing object-oriented services will be briefly described, and matters not described herein are described above with reference to FIGS. 1, 2 and 3.

Referring to FIG. 4, the method of providing object-oriented services includes, in addition to the method of providing object-oriented services illustrated in FIG. 3: acquiring information on a service using entity or a service providing entity that is connected to a service network in S401; and/or generating a pool of service objects based on at least one service using entity and at least one service providing entity in S402.

In the method of providing object-oriented services illustrated in FIG. 4, information on a service using entity or a service providing entity is acquired in S401.

Then, a pool of service objects is generated based on at least one service using entity and at least one service providing entity in S402.

Subsequently, in the method of providing object-oriented services, a service relationship is analyzed by dividing service objects into a service requesting object and a service providing object based on information on the service objects in S403, for services that may be transmitted and received between service objects.

Next, services that may be transmitted and received between the objects may be generated by using the analyzed service relationship in S404.

Then, a plurality of objects in the generated services are divided into a service requesting object and a service providing object, and in response to a request of the service requesting object, the service providing object outputs the services to the service requesting object in S405.

As described above, according to an exemplary embodiment, object-oriented services may be provided in a smart home environment by analyzing a service flow relationship between a user and an object and between objects.

Further, according to an exemplary embodiment, by using an object knowledge base established by analyzing a relationship between objects, services may be provided not only to an object that requests the services, but also to an object that may receive the services, thereby expanding a range of subjects and services.

The method of providing object-oriented services may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The program instructions of the medium may be designed or configured specially for the present invention, or may be used well-known to those who are skilled in the art. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. The medium may be a transmission medium such as an optical fiber, a metal wire and a waveguide, which includes carrier waves that transmits signals for defining program instructions or data structures. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. An apparatus for providing object-oriented services, the apparatus comprising:
an object pool generator configured to generate a pool of service objects based on at least one service using entity and at least one service providing entity;
a service relationship analyzer configured to analyze a service relationship by dividing the service objects into a service requesting object and a service providing object based on information on the service objects, for services capable of being transmitted and received between the service objects; and
a service generator configured to generate the services, capable of being transmitted and received between the service objects, by using the analyzed service relationship.

2. The apparatus claim 1, wherein the service objects are objects which request or provide the services.

3. The apparatus of claim 1, wherein the service relationship analyzer analyzes the service relationship by dividing the service objects into the service requesting object and the service providing object, wherein the service relationship includes information on whether the service objects have received the services.

4. The apparatus of claim 1, wherein the service generator generates a mashup service, wherein one or more services capable of being transmitted and received between the service objects have been mashed up, by using the analyzed service relationship.

5. The apparatus of claim 1, further comprising an information acquirer configured to acquire information on the service using entity or the service providing entity that is connected to a service network.

6. The apparatus of claim 1, further comprising a service output component configured to divide a plurality of objects in the services, generated by the service generator, into the service requesting object and the service providing object, and to output the services by the service providing object to the service requesting object in response to a request of the service requesting object.

7. The apparatus of claim 1, further comprising a service list output component configured to output a list of the services capable of being provided to the service requesting object.

8. A method of providing object-oriented services, the method comprising:
analyzing a service relationship by dividing service objects into a service requesting object and a service providing object by using information on the service objects for services capable of being transmitted and received between the service objects;
generating the services capable of being transmitted and received between the service objects by using the analyzed service relationship; and
dividing a plurality of objects in the generated services into the service requesting object and the service providing object, and outputting the services by the service providing object to the service requesting object in response to a service request of the service requesting object.

9. The method of claim 8, further comprising generating a pool of the service objects based on at least one service using entity and at least one service providing entity.

10. The method of claim 8, wherein the service objects are objects which request or provide the services.

11. The method of claim 8, wherein the analyzing of the service relationship comprises analyzing the service relationship by dividing the service objects into the service requesting object and the service providing object, wherein the service relationship includes information on whether the service objects have received the services.

12. The method of claim 8, wherein the generating of the service comprises generating a mashup service, wherein one or more services capable of being transmitted and received between the service objects have been mashed up, by using the analyzed service relationship.

13. The method of claim 8, further comprising acquiring information on the service using entity or the service providing entity that is connected to a service network.

14. The method of claim 8, further comprising outputting a list of the services capable of being provided to the service requesting object.
